(19) United States
(12) Patent Application Publication
(10) Pub. No.: US 2012/0256718 A1
(43) Pub. Date: Oct. 11, 2012

(54) Inductor Construction for Power Conversion Module

(76) Inventor: Muzahid Bin Huda, Los Gatos, CA (US)

(21) Appl. No.: 13/441,263

(22) Filed: Apr. 6, 2012

Related U.S. Application Data
(60) Provisional application No. 61/516,805, filed on Apr. 8, 2011.

(51) Int. Cl. H01F 27/255; H01F 27/02; H01F 27/08; H01F 27/36; H01F 27/29

(52) U.S. Cl. 336/61; 336/221; 336/84 C; 336/192; 336/82

(57) ABSTRACT

Unique methods are described to construct an inductor in the form of a tray. The basic inductor consists of a ferromagnetic core with a cavity and a completely or partially embedded winding structure. Components of a power conversion system or sub-system are mounted inside this tray structure. The terminals of the winding structure serve as mounting surfaces for components of a power conversion or other type of electronic system or sub-system. The single winding inductor is also extended to multi-winding inductors. The winding terminations are shaped to form Kelvin connections for current sensing. Flanges are added to the winding structure forming an integrated heat sink.

### CROSS REFERENCE TO RELATED APPLICATION

This application claims priority from and incorporates by reference the following U.S. Provisional Application: “Inductor Construction for Power Conversion Module”, Ser. No. 61/516,805 filed on Apr. 8, 2011.

### BACKGROUND OF THE INVENTION

1. Field of the Invention

The field of the present invention pertains to electrical power conversion. The present invention relates to an inductor structure designed for single and multi-output power conversion systems.

2. Description of Related Art

This disclosure describes several unique construction methods of an inductor to enable an overall reduction in the footprint and volume of a power conversion system.

Information related to this immediate area of the invention is found in: “Power Conversion System using Ferromagnetic Enclosure with Embedded Winding to serve as Magnetic Component”, application Ser. No. 13/411,568, also filed by the present inventor, on Mar. 4, 2012. Additionally, information relevant to attempts at addressing these problems are found in:
a) US Patent no. US 2002/0017972 A1 issued to Han-Cheng, Hsu, Dated Feb. 14, 2002
b) U.S. Pat. No. 7,864,015 B2 Thomas T. Hansen et.al, “Flux Channeled High Current Inductor”, Dated Jan. 4, 2011

### SUMMARY OF THE INVENTION

This invention describes the construction of an inductor in the form of a tray structure. All or some of the components of a power conversion system or sub-system are mounted inside this tray structure to achieve more optimal electrical and thermal performance. The inductor consists of one or more windings made of electrical conductors partially or fully embedded in a single or multi-piece ferromagnetic core. The winding conductors serve the following functions: a) They constitute the windings of the inductor, b) They serve as support structures on which components of the power conversion system or sub-system are mounted, c) They provide direct electrical connection between components, between components and the inductor; it also provides electrical connections between components and one or more external system substrates, d) they offer a means of optimal heat transfer from the power conversion system or sub-system to areas of the inductor where it can be efficiently radiated or conducted away, e) the winding terminals are shaped in the form of Kelvin connections to facilitate accurate current sensing and f) the winding terminals are shaped and extended in a fashion that facilitates a reduction in the number of interconnects in the high current path between the power conversion system or sub-system and an external system substrate.

### BRIEF DESCRIPTION OF THE DRAWINGS

FIG. 1A illustrates the construction of one embodiment of the inductor in the form of a tray structure, employing low permeability ferromagnetic materials such as powdered iron.

FIG. 1B illustrates the cross-section of the inductor shown in FIG. 1A taken along the line A-A′.

FIG. 1C illustrates one embodiment of the winding in the inductor shown in FIG. 1A.

FIG. 1D illustrates another embodiment of the winding structure with flanges added to improve thermal performance of the system.

FIG. 1E FIG. 1F, FIG. 1G, FIG. 1H illustrate variations of the inductor winding terminations.

FIG. 2A illustrates the construction of one embodiment of the surface mount inductor in the form of a tray structure, employing high permeability ferromagnetic materials such as Ferrite.

FIG. 2B illustrates the construction of one embodiment of the through-hole inductor in the form of a tray structure, employing high permeability ferromagnetic materials such as Ferrite.

FIG. 2C illustrates the cross-section of the inductor shown in FIG. 2A taken along the line B-B′.

FIG. 3A illustrates the bottom view of one embodiment of the two-winding inductor structure employing low permeability ferromagnetic materials.

FIG. 3B illustrates the cross-section of the inductor shown in FIG. 3A taken along the line C-C′.

FIG. 3C illustrates one embodiment of the winding arrangement for the inductor shown in FIG. 3A.

FIG. 3D illustrates another embodiment of the winding arrangement for the inductor.

FIG. 4A illustrates the bottom view of one embodiment of the two-winding inductor structure employing high permeability ferromagnetic materials.

FIG. 4B illustrates the cross-section of the inductor shown in FIG. 4A taken along the line D-D′.

FIG. 5A illustrates the bottom view of one embodiment of the four-winding inductor structure employing low permeability ferromagnetic materials.

FIG. 5B illustrates one embodiment of the winding arrangement for the inductor shown in FIG. 5A.

FIG. 6 illustrates the bottom view of one embodiment of the four-winding inductor structure employing high permeability ferromagnetic materials.

### DETAILED DESCRIPTION

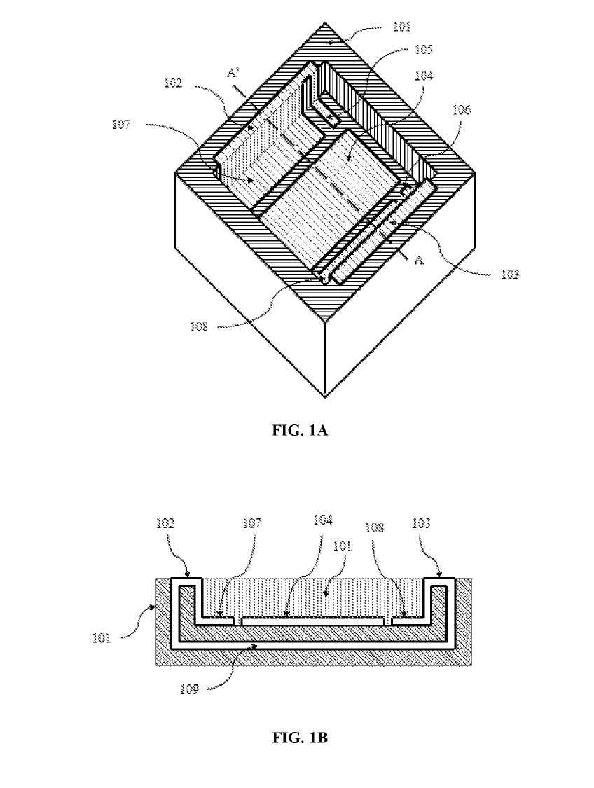

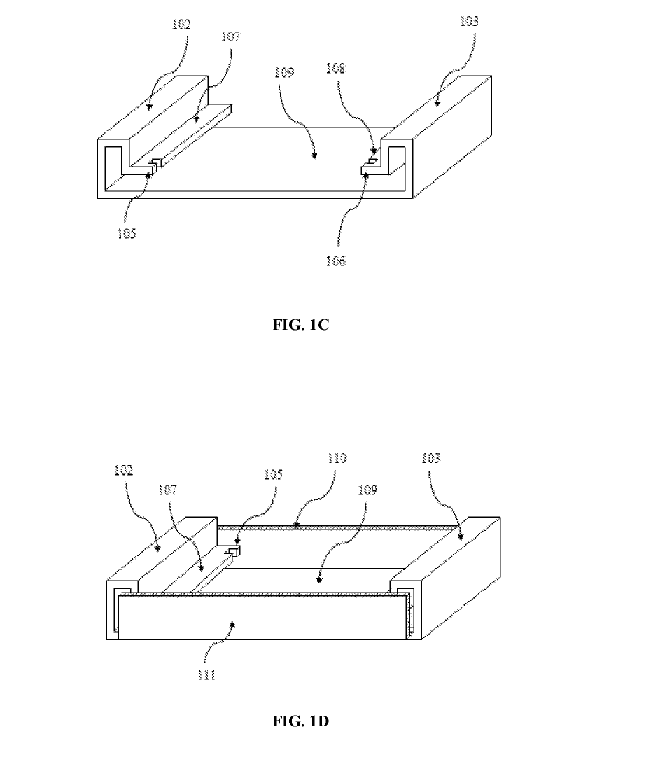

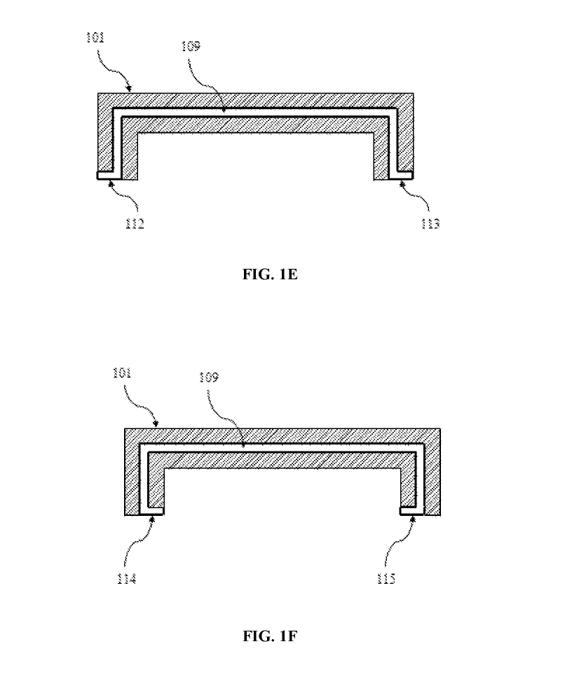

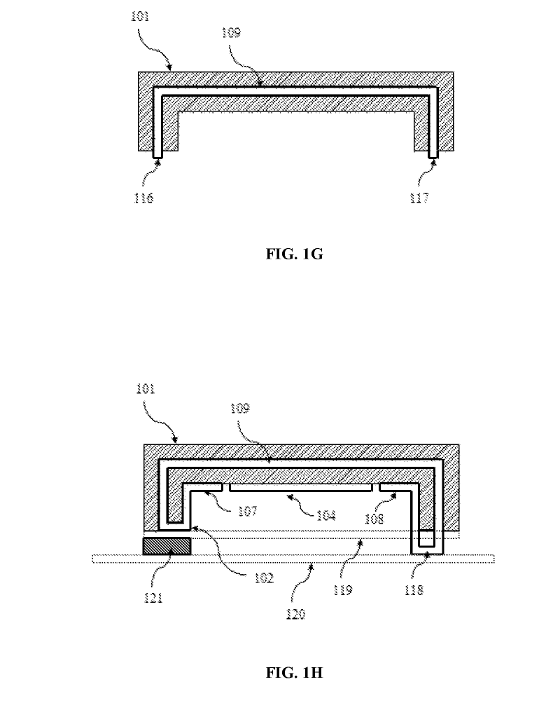

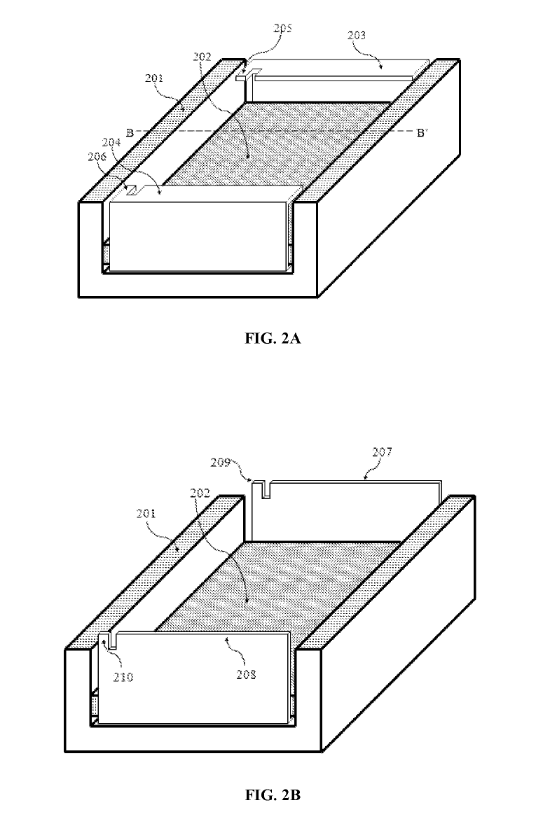

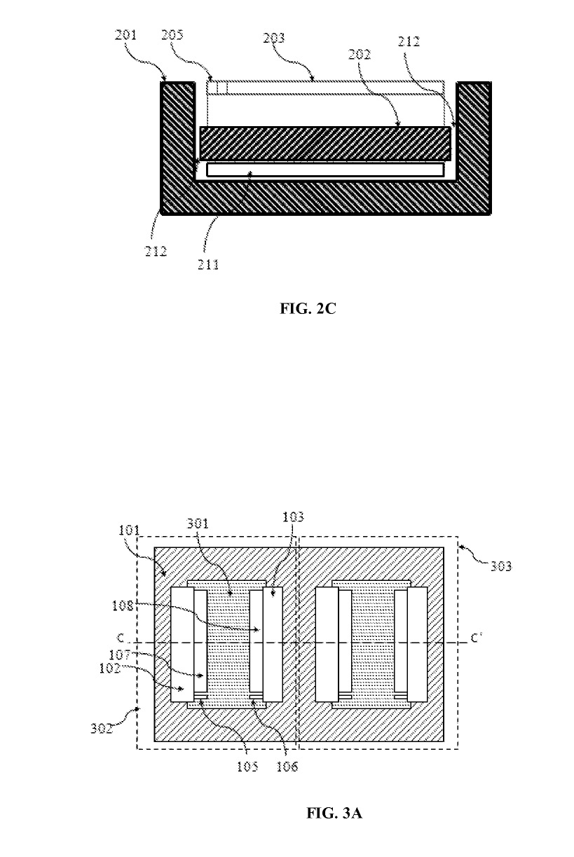

Two primary embodiments of the construction and their variations of the ferromagnetic inductor are described in this disclosure. The two primary embodiments are as follows:
1) A ferromagnetic inductor built in the form of a tray (FIG. 1A) using a core of low permeability material such as powdered iron, and
2) A ferromagnetic inductor built in the form of a tray (FIG. 2A) using a core of high permeability material such as ferrite.

The variations of the above embodiments described in this disclosure are as follows:
a) A single-winding inductor embodiment,
b) A two-winding inductor embodiment, and
c) A multi-winding inductor embodiment.
   Furthermore, construction details of the winding structures associated with the two primary embodiments and their variations are described.

The embodiments and their variations described have arbitrary outer and cross sectional shape, area and volume, beyond those that are specifically described in this disclosure. Examples of the outer and cross-sectional shapes of the inductor include, but are not limited to, rectangular-cylindrical, circular-cylindrical, oval-cylindrical, triangular-cylindrical, or any other arbitrary symmetrical or non-symmetrical shape, etc.

FIG. 1A shows the construction of one embodiment of the inductor shaped in the form of a tray. 101 is the core of the inductor made of low permeability material such as powdered iron. 102 and 103 are the inductor's power terminals. 104 is an isolated conductor, that is used for making connections to a power conversion circuit as a grounded or ungrounded shield. 105 and 106 are terminals arbitrarily located on 102 and 103 respectively, and shaped to serve as Kelvin-connections for accurate current sensing. 107 and 108 are extensions of the terminals of the inductor appropriately shaped and folded into the tray cavity to serve as mounting surfaces for components of a power conversion system or sub-system. 107 and 108 are also used as electrical and thermal connections.

FIG. 1B shows the cross sectional view taken along the line A-A′ for the inductor of FIG. 1A. This view shows one method of embedding the winding inside the core (101). 109 is the portion of the winding structure that is buried inside the core.

FIG. 1C shows the detailed view of one embodiment of the winding structure. This structure is used as the inductor winding for inductors constructed using both low and high permeability ferromagnetic materials.

FIG. 1D is another embodiment of the winding structure. 110 and 111 are flanges added to function as an integrated heat sink to improve thermal performance and also provide structural integrity of the inductor structure. In one embodiment of the inductor, 110 and 111 are folded upward, downward or extended horizontally inside the core to achieve optimal thermal performance. In yet another embodiment 110 and 111 are folded upward, downward or extended horizontally and extend outside the core to achieve optimal thermal performance.

FIG. 1E and FIG. 1F show surface mount winding termination shapes for the inductor. In FIG. 1E, the two terminals 112 and 113 are bent outwards and in FIG. 1F the two terminals 114 and 115 are shown bent inwards. In FIG. 1G, 116 and 117 are through-hole winding terminations for the inductor.

FIG. 1H shows one embodiment of the inductor structure in which the terminals are shaped to facilitate optimum electrical connections to the power system or sub-system. The inductor structure, along with other components of the power system or sub-system not shown, is mounted on a first substrate, 119. 118 is the extended inductor terminal passing through 119 and making direct electrical connection to both 119 and a second substrate 120.

121 is a separate conductor that is not part of the inductor structure, but serves as an interconnect between 119 and 120.

FIG. 2A shows the construction of another surface mount embodiment of the inductor using a high permeability core such as, but not limited to ferrite. 201 and 202 form a two piece core structure. 203 and 204 are the inductor's power terminals. 205 and 206 are terminals arbitrarily located on 203 and 204 respectively, and shaped to serve as Kelvin-connections for accurate current sensing.

FIG. 2B shows the through hole embodiment of the inductor structure shown in FIG. 2A. 207 and 208 in FIG. 2B indicate the power terminals shaped to allow the inductor to be mounted as a through hole component. 209 and 210 are current sensing Kelvin connections.

FIG. 2C shows the cross sectional view taken along the line B-B′ for the inductor of FIG. 2A. This view shows a detailed view of how the two piece core structure, air gaps and the winding arrangement are incorporated into the inductor. 201 and 202 are the two pieces of the high permeability core described earlier. 212 shows air gaps of arbitrary numbers and dimensions. 211 is the portion of the winding structure embedded in the core. The width of 211 is arbitrarily smaller than that of 202.

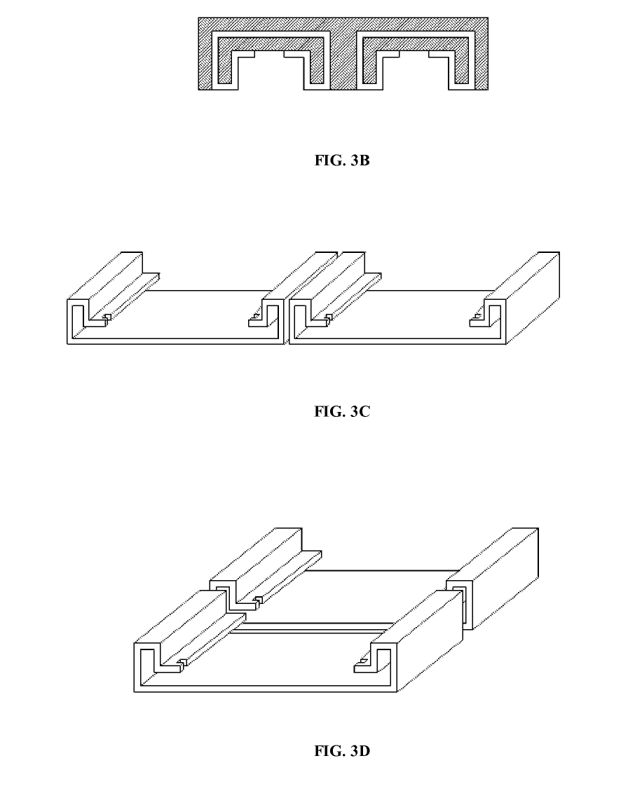

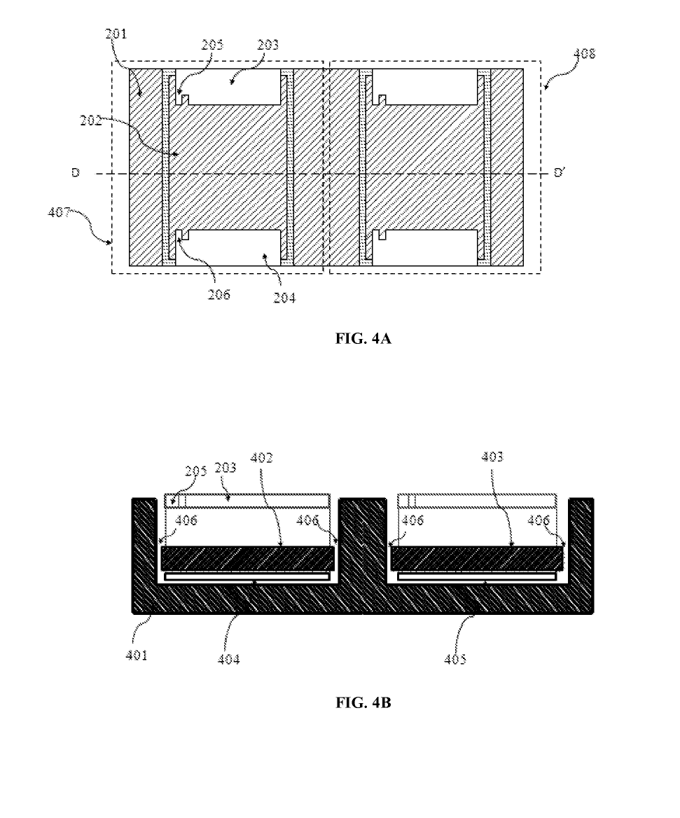

FIG. 3A shows the bottom view of one embodiment of a two-winding inductor structure using low permeability material for the core. The dashed box 302 represents the totality of the bottom view of the single-winding inductor structure shown earlier in FIG. 1A. 301 is the floor of the tray structure on which 104, not shown, is optionally mounted. The dashed box 303 is identical to 302. The two windings of FIG. 3A can be arranged to provide either a single output or two independent outputs.

FIG. 3B shows the cross sectional view of FIG. 3A taken along the line C-C′.

FIG. 3C shows the arrangement of the two windings used in the inductor structure shown in FIG. 3A. FIG. 3D shows another embodiment of the winding arrangement for two-winding structures.

FIG. 4A shows the bottom view of one embodiment of a two-winding inductor structure using a high permeability material for the core. The dashed box 407 represents the totality of the bottom view of the single-winding inductor structure shown earlier in FIG. 2A. The dashed box 408 is identical to 407. The two windings of FIG. 4A can be arranged to provide either a single output or two independent outputs.

FIG. 4B shows the detailed cross sectional view of FIG. 4A taken along the line D-D′. 401, 402 and 403 form the three-piece core structure. 404 and 405 are portions of each winding structure embedded in the core. 406 shows air gaps of arbitrary number and shapes.

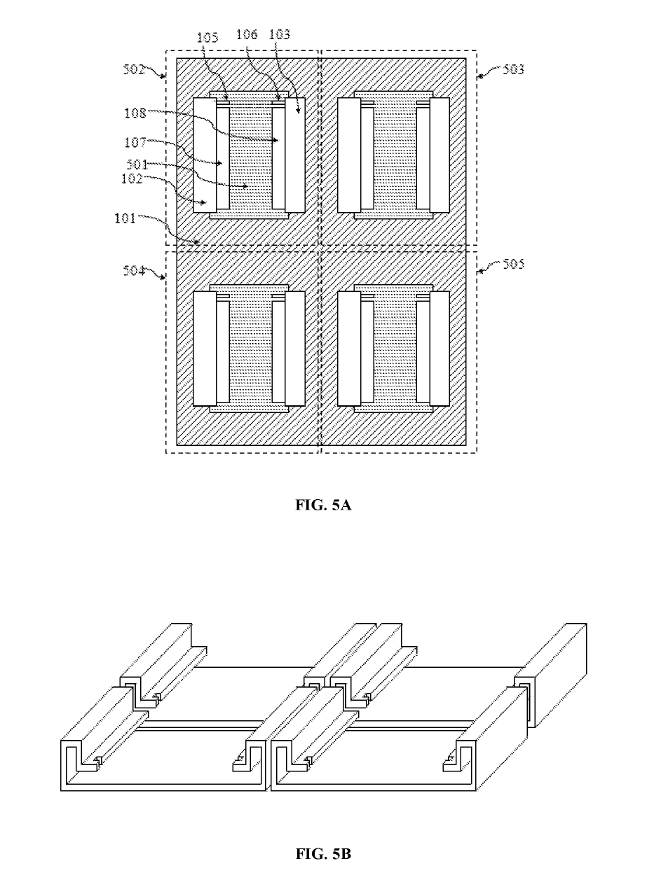

FIG. 5A shows the bottom view of one embodiment of a four-winding inductor structure using a low permeability material for the core. The dashed box 502 represents the bottom view of the single-winding inductor structure shown earlier in FIG. 1A. The dashed boxes 503, 504 and 505 are identical to 502. The four windings of FIG. 5A can be arranged to provide either a single, two, three or four independent outputs. This structure can be expanded in any direction to construct a single or n-output inductor structure, where n is an arbitrary number.

FIG. 5B shows the arrangement of the four windings used in the inductor structure shown in FIG. 5A.

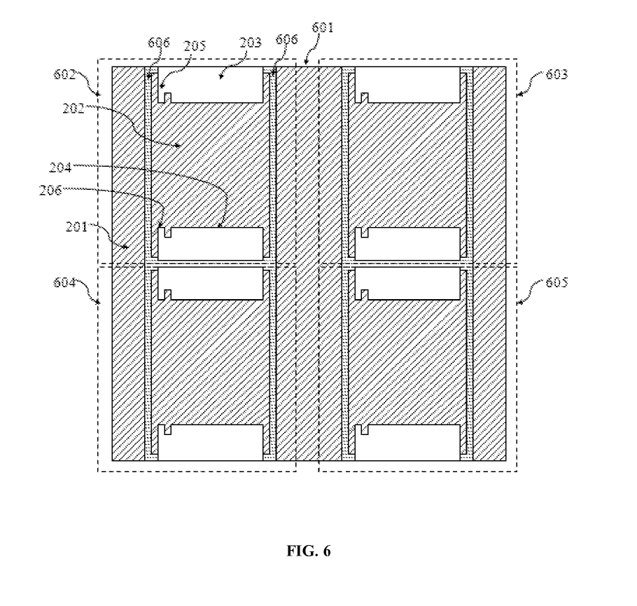

FIG. 6 shows the bottom view of one embodiment of a four-winding inductor structure using a high permeability material for the core. The dashed box 602 represents the bottom view of the single-winding inductor structure shown earlier in FIG. 2A. The dashed boxes 603, 604 and 605 are identical to 602. The four windings of FIG. 6 can be arranged to provide either a single, two, three or four independent outputs. This structure can be expanded in any direction to construct a single or n-output inductor structure, where n is an arbitrary number.

What is claimed is:

1. An inductor structure consisting of a core of low permeability material such as, but not limited to powdered-iron, formed in the shape of a single cavity tray, and also consisting of an arbitrary number of windings. For reference, see FIG. 1A for one example of an embodiment.

2. An inductor structure consisting of a core of high permeability material such as, but not limited to ferrite, formed in the shape of a single cavity tray, and also consisting of an arbitrary number of windings. For reference, see FIG. 2A for one example of an embodiment.

3. An inductor structure consisting of a core of low permeability material such as, but not limited to powdered-iron, formed in the shape of a tray with more than one cavity, and more than one winding. For reference, see FIG. 3A and FIG. 5A for examples of embodiment.

4. An inductor structure consisting of a core of high permeability material such as, but not limited to ferrite, formed in the shape of a tray with more than one cavity, and also consisting of more than one winding. For reference, see FIG. 4A and FIG. 6 for examples of embodiment.

5. The windings in the inductor structures of claims 1, 2, 3 and 4 are embedded wholly or partially within the core.

6. In one embodiment, the windings in the inductor structures of claims 1, 2, 3 and 4, are constructed from low TCR conducting material (alloys).

7. In another embodiment, the windings in the inductor structures of claims 1, 2, 3 and 4, are constructed from standard, non-alloy conducting materials.

8. The windings in the inductor structures of claims 1, 2, 3 and 4 are constructed of an arbitrary number of turns and layers, shapes and sizes.

9. The inductor structures of claims 1, 2, 3 and 4 consist of windings with terminals shaped to serve as one or more mounting surfaces for components to assemble one or more power conversion systems or sub-systems. For reference, see FIG. 1B for one example of an embodiment.

10. The inductor structures of claims 1, 2, 3 and 4 consist of one or more conductors that are not part of the windings but are used for mounting components and to serve as shields between the core and the circuit of the power conversion system or systems. For reference, see 104 in FIG. 1B for one example of an embodiment.

11. The inductor structures of claims 1, 2, 3 and 4 consist of one or more conductor windings in which the terminals are shaped to form Kelvin connections for facilitating accurate current sensing. For reference, see 105 and 106 in FIG. 1C for one example of an embodiment.

12. The inductor structures of claims 1, 2, 3 and 4 consist of windings with none, one or more terminals that are shaped and extended to serve as input or output electrical power connections to an external mounting surface. See 118 in FIG. 1H for reference for one example of an embodiment.

13. Flanges on the windings of the inductor structures of claims 1, 2, 3 and 4 are used as an integrated heat sink. For reference se FIG. 1D for one example of an embodiment.

14. In one embodiment, the windings of the inductor structures of claims 1, 2, 3 and 4 provide structural support for the core. For reference see 110 and 111 in FIG. 1D for one example of an embodiment.

15. The inductor structures of claims 1, 2, 3 and 4 are used as stand-alone components in a power conversion system or sub-system, and also for other electronic signal processing systems and subsystems.

16. The inductor structures of claims 1, 2, 3 and 4 are used as the housing by enclosing the components of one or more power conversion systems or sub-systems, and also for other electronic signal processing systems and subsystems.

17. The core of the inductor structure of claims 1, 2, 3 and 4 is of any arbitrary outer and cross sectional shape, area and volume. Examples of the outer and cross-sectional shapes of the inductor structure include, but are not limited to rectangular-cylindrical, circular-cylindrical, oval-cylindrical, triangular-cylindrical, or any other arbitrary symmetrical or non-symmetrical shape.
